(19) United States
(12) Patent Application Publication
(10) Pub. No.: US 2011/0052878 A1
(43) Pub. Date: Mar. 3, 2011

(54) DECORATING CLOTH PROVIDED WITH THE EFFECT OF STEREOSCOPIC VISION

(76) Inventors: Wen-Shan LIN, Taichung (TW); Hsiu-Mei Lin, Taichung (TW)

(21) Appl. No.: 12/548,518

(22) Filed: Aug. 27, 2009

(51) Int. Cl. B32B 3/00

(52) U.S. Cl. 428/161

(57) ABSTRACT

A decorating cloth provided with the effect of stereoscopic vision essentially includes a substrate. The top surface of substrate is formed with a 3D layer. The 3D layer is formed with a plurality of silks made of a thermoplastic material that is interlaced in a three-dimensional space, so the surface of substrate is formed with the effect of stereoscopic vision. Thus, the decorating cloth may be applied to various goods to make the appearance of goods to be formed with three dimensions, the value of cloth being thereby added for better sale. Further, the strips of silks are more stiffened ones, so the article is more washable and wear-proof.

### BACKGROUND OF THE INVENTION

1. Field of the Invention

This invention relates to a decorating cloth provided with the effect of stereoscopic vision.

2. Description of the Prior Art

A conventional decorating cloth is soft, delicate in the tactile impression, it is formed without three dimension in the application of decoration; thus, shoes and backpacks made of the decorating cloth are slightly more dull in the sense of vision and are not diverse. Thus, in the market, applying variable colors and using the embossing apparently brings the effect of stereoscopic vision. However, the effect of stereoscopic vision brought in the manners is not obvious, and abrasion is easily caused; thus, it is apparent that improvement is necessarily made.

Consequently, because of the technical defects of described above, the applicant keeps on carving unflaggingly through wholehearted experience and research to develop the present invention, which can effectively improve the defects described above.

### SUMMARY OF THE INVENTION

A decorating cloth provided with the effect of stereoscopic vision according to this invention essentially comprises a substrate of which the top surface is formed with a 3D layer. The 3D layer is formed with a plurality of silks made of a thermoplastic material that is interlaced in a three-dimensional space, so the surface of substrate is formed with the effect of stereoscopic vision. Thus, the decorating cloth may be applied to various goods to make the appearance of goods to be formed with three dimensions, the value of cloth being thereby added for better sale. Further, the strips of silks are more stiffened ones, so the article is more washable and wear-proof.

### BRIEF DESCRIPTION OF THE DRAWINGS

FIG. 1 is a 3D view of a decorating cloth according to this invention in a preferred embodiment;

FIG. 2 is a sectional view of the decorating cloth according to this invention; and

FIG. 3 is a schematic view illustrating the use of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

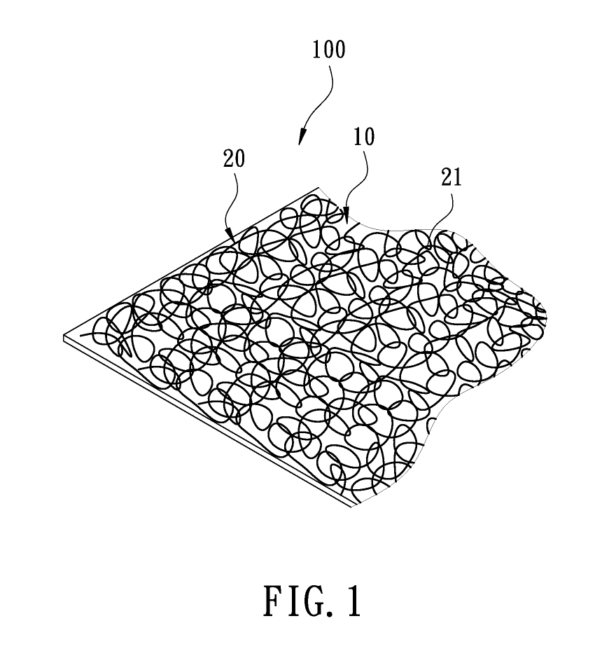

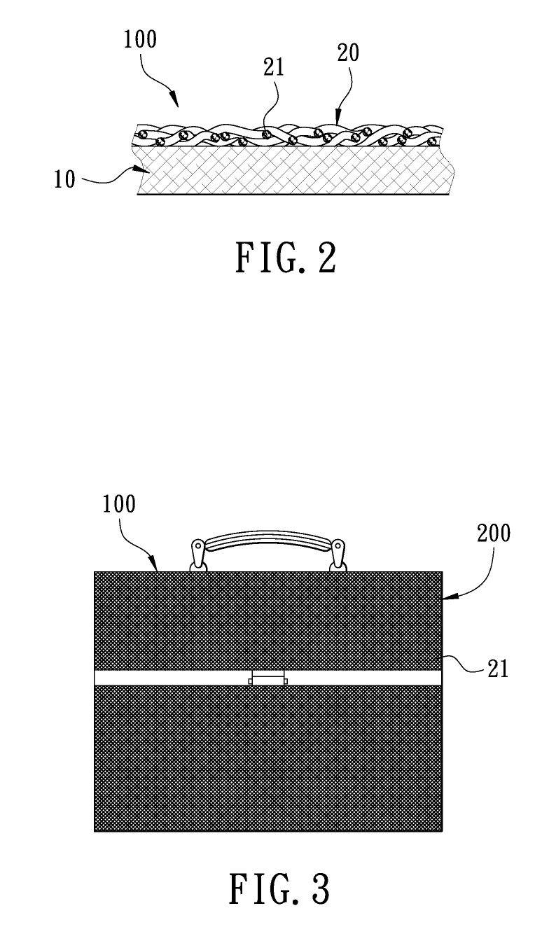

With reference to FIGS. 1 and 2 shown as a 3D view and a sectional view that illustrate a decorating cloth according to the present invention in a preferred embodiment, the decorating cloth 100 essentially comprises a substrate 10. The substrate 10 may be a cotton cloth, a fiber weaved cloth, a leather, a paper, or a timber. The top surface of substrate 10 is formed with a 3D layer 20. The 3D layer 20 is formed with a plurality of silks 21 made of a thermoplastic material that is interlaced in a three-dimensional space. The silks 21 made of a thermoplastic material may be PVC, PU, PP, or PE. The trips of silks 21 are arranged regularly in parallel with each other or arranged irregularly in this embodiment and thus the surface of substrate 10 is formed with the effect of irregular stereoscopic vision. Further, after being heated by an extrusion equipment, the strips of silks 21 are poured onto the substrate 10, and before being cooled and solidified, the strips of silks 21 are rolled by a roller to directly adhere onto and combine with the substrate 10, which reaches the effect of adhesion without adhesive and shortens the manufacturing process. With the roller, the thickness of 3D layer 20 may further controlled.

With reference to FIG. 3 as a schematic view illustrating the operation of the present invention, the decorating cloth 100 may be applied to various goods, such as shoes, backpacks, curtains and the like. In this embodiment, the decorating cloth 100 is sewn into a handbag 200, and the trips of silks 21 are arranged regularly in parallel with each other. Thus, grids of stereoscopic vision are formed at the appearance of handbag 200, the value of cloth being thereby added for better sale. Further, the strips of silks 21 of the decorating cloth 100 are more stiffened ones, so the handbag 200 is more washable and wear-proof. Next, the substrate 10 and silks 21 of the decorating cloth 100 may have different colors and further bring the outstanding effect of stereoscopic vision.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A decorating cloth provided with the effect of stereoscopic vision, essentially comprising:
a substrate; and
a 3D layer, being formed on the top surface of substrate and formed with a plurality of silks made of a thermoplastic material that is interlaced in a three-dimensional space, the surface of substrate being thereby formed with the effect of stereoscopic vision.

2. The decorating cloth provided with the effect of stereoscopic vision according to claim 1, wherein the substrate is formed with a cotton cloth.

3. The decorating cloth provided with the effect of stereoscopic vision according to claim 1, wherein the strips of thermoplastic silks are made of PU.

4. The decorating cloth provided with the effect of stereoscopic vision according to claim 1, wherein the strips of silks are arranged irregularly.

5. The decorating cloth provided with the effect of stereoscopic vision according to claim 1, wherein the substrate and the 3D layer have different colors.

6. The decorating cloth provided with the effect of stereoscopic vision according to claim 1, wherein the 3d layer on the substrate is pressed and formed in certain thickness.
